(19) United States
(12) Patent Application Publication
(10) Pub. No.: US 2011/0052913 A1
(43) Pub. Date: Mar. 3, 2011

(54) MONOFILAMENT FIBERS COMPRISING AT LEAST ONE FILLER, AND PROCESSES FOR THEIR PRODUCTION

(76) Inventor: Larry McAmish, Marietta, GA (US)

(21) Appl. No.: 12/863,341

(22) PCT Filed: Jan. 19, 2009
(86) PCT No.: PCT/US09/31397

§ 371 Date: Jul. 16, 2010

(30) Foreign Application Priority Data
Jan. 21, 2008 (US) 61/022458
Mar. 31, 2008 (US) 61041237

(51) Int. Cl. C08F 8/00; D01D 5/00; B29C 47/00

(52) U.S. Cl. 428/372; 264/176.1

(57) ABSTRACT

Disclosed herein are monofilament fibers comprising at least one polymeric resin and at least one coated filler, wherein the at least one coated filler has an average particle size of less than or equal to about 3 microns and/or has a top cut of less than or equal to about 10 microns, and wherein the at least one coated filler is present in an amount of less than or equal to about 50% by weight, relative to the total weight of the monofilament fibers. Also disclosed herein are methods for producing monofilament fibers comprising adding ground calcium carbonate to at least one polymeric resin and extruding the resulting mixture.

### CLAIM OF PRIORITY

This PCT international application hereby claims the rights and benefits of priority to U.S. Provisional Patent Application No. 61/041,237 filed Mar. 31, 2008, and U.S. Provisional Patent Application No. 61/022,458 filed Jan. 21, 2008, both of which are incorporated by reference herein in their entireties.

### FIELD OF THE INVENTION

This application and the inventions described herein generally discuss and relate to monofilament fibers comprising fillers such as coated ground calcium carbonate.

### BACKGROUND OF THE INVENTION

Many commercial products are formed from components that may include monofilament fibers of polymeric resins. For instance, monofilament fibers may be used to make staple fibers, yarns, fishing line, woven fabrics, non-woven fabrics, artificial furs, diapers, feminine hygiene products, adult incontinence products, packaging materials, wipes, towels, industrial garments, medical drapes, medical gowns, foot covers, sterilization wraps, table cloths, paint brushes, napkins, trash bags, and various personal care articles.

Monofilament fibers are generally made by melt spinning, dry spinning, or wet spinning. In particular, monofilament fibers may be produced by spinning a polymeric resin into the shape of a fiber, for example, by heating the resin at least to its softening temperature and extruding the resin through a spinneret to form monofilament fibers. Monofilament fibers may also be produced by extruding the resin and attenuating the streams of resin by hot air to form fibers with a fine diameter.

The textile industry consumes a large amount of thermoplastic polymeric resin each year, about 300 million pounds of monofilament fiber. While it is known to incorporate various mineral fillers such as calcium carbonate and kaolin during production of non-woven products and plastic products such as films and molded parts, it is not currently the general practice to include large amounts of such fillers in monofilament fibers. Previously, the cost of virgin resin was lower than the cost of concentrates composed of resins and mineral fillers and, thus, no need existed for incorporating appreciable amounts of such fillers. However, increases in resin prices have created, in many instances, a cost benefit associated with increasing the quantity of mineral fillers and decreasing the quantity of resin in many products. By incorporating at least one mineral filler, for example, calcium carbonate, the required amount of virgin resin material decreases while the end product may have comparable quality in areas including but not limited to fiber strength, texture, and appearance.

Products comprising various amounts of inorganic compounds and/or mineral fillers have been known. For example, U.S. Pat. No. 6,797,377 appears to disclose non-woven webs comprising from 0.1 to 10 wt % of at least one mineral filler such as calcium carbonate, but imposes the limitation of the filler being used in conjunction with titanium dioxide in a mixture of at least two resin polymers. U.S. Pat. No. 6,759,357 likewise appears to disclose fabrics comprising from 0.0015 to 0.09 wt % of at least one inorganic compound. S, Nago and Y. Mizutani, Microporous Polypropylene Fibers Containing CaCO₃ Filler, 62 J. Appl. Polymer Sci. 81-86 (1996), also appears to discuss polypropylene-based non-woven fibers comprising 25 wt % calcium carbonate. WO 97/30199 may disclose fibers consisting essentially of about 0.01 to about 20 wt % inorganic particles, substantially all having a Mohs hardness of less than about 5 and at least about 90 wt % of the inorganic particles having a particle size of less than about 10 microns. However, none of these references appear to disclose reducing the impact of the filler on the properties of the final monofilament fibers at least through changes to the particle size of the coated ground calcium carbonate by its average particle size and/or by its top cut.

A need exists for monofilament fibers comprising larger quantities of at least one filler, such as calcium carbonate, without a loss of desirable physical and/or chemical properties associated with monofilament fibers with lower quantities or no quantity of fillers. The present inventors have surprisingly and unexpectedly found that varying the particle size of the at least one filler, such as decreasing it below about 10 microns, allows the product fibers to retain desirable properties while increasing the overall quantity (measured as wt %) of filler.

### BRIEF DESCRIPTION OF THE FIGURES

FIG. 1 is graph showing the maximum force applied to each monofilament fiber before the fiber would break (“max load”) for each percentage of stearic acid coated ground calcium carbonate in the fiber.

FIG. 2 is a graph showing the percent elongation of the monofilament fibers for each percentage of stearic acid coated ground calcium carbonate in the fiber.

FIG. 3 is a graph showing the tenacity of the monofilament fibers for each percentage of stearic acid coated ground calcium carbonate in the fiber.

### SUMMARY OF THE INVENTION

This application generally discloses monofilament fibers comprising at least one polymeric resin and at least one filler, such as coated ground calcium carbonate (GCC), having an average particle size less than or equal to about 3 microns, wherein the at least one filler is present in the fibers in an amount of less than or equal to about 50% by weight, relative to the total weight of the fibers. In addition, this application generally discloses monofilament fibers comprising at least one polymeric resin and at least one filler, such as coated ground calcium carbonate, having a top cut of less than or equal to about 10 microns, wherein the at least one filler is present in an amount of less than about 50% by weight, relative to the total weight of the fibers.

Also disclosed herein is a method for producing monofilament fibers, comprising adding at least one filler to at least one polymeric resin and extruding the resulting mixture, wherein the at least one filler is present in the final product in an amount of less than or equal to about 50% by weight. In one embodiment, the at least one filler has an average particle size of less than or equal to about 3 microns. In another embodiment, the at least one filler has a top cut of less than or equal to about 10 microns. In a further embodiment, the at least one filler is coated ground calcium carbonate.

### DETAILED DESCRIPTION OF THE INVENTION

### Monofilament Fibers

As used herein, the term “fiber” includes not only conventional single fibers and filaments, but also yarns made from a multiplicity of these fibers. In general, yarns are utilized in the manufacture of apparel, fabrics, and the like. Fibers and yarns, such as those described above, can be made into fabrics using any methods currently used or hereafter discovered for making fibers and yarns into fabrics, including but not limited to weaving and knitting. Fibers and yarns can also be made into non-woven fabrics using any methods currently used or hereafter discovered.

Polymeric Resin

The monofilament fibers disclosed herein comprise at least one polymeric resin. The skilled artisan will readily understand appropriate polymeric resins for use in the described inventions. In one embodiment, the at least one polymeric resin is chosen from conventional polymeric resins that provide the properties desired for any particular yarn, woven product, non-woven product, or application. In another embodiment, the at least one polymeric resin is chosen from thermoplastic polymers, including but not limited to: polyolefins, such as polypropylene and polyethylene homopolymers and copolymers, including copolymers with 1-butene, 4-methyl-1-pentene, and 1-hexane; polyamides, such as nylon; polyesters; and copolymers of any of the above-mentioned polymers.

In one embodiment, the at least one polymeric resin is an isotropic semi-crystalline polymer. In one embodiment, the isotropic semi-crystalline polymer is melt-processable, melting in a temperature range that makes it possible to spin the polymer into fibers in the melt phase without significant decomposition. Exemplary isotropic semi-crystalline polymers include, but are not limited to, poly(alkylene terephthalates); poly(alkylene naphthalates); poly(arylene sulfides); aliphatic and aliphatic-aromatic polyamides; polyesters comprising monomer units derived from cyclohexanedimethanol and terephthalic acid; poly(ethylene terephthalate); poly(butylene terephthalate); poly(ethylene naphthalate); poly(phenylene sulfide); and poly(1,4-cyclohexanedimethanol terephthalate), wherein the 1,4-cyclohexanedimethanol is a mixture of cis- and trans-isomers, nylon-6, and nylon-66. In another embodiment, the at least one polymeric resin is a semi-crystalline polymer polyolefin, including but not limited to polyethylene and polypropylene. In a further embodiment, the at least one polymeric resin is extended chain polyethylene having a high tensile modulus, made by the gel spinning or the melt spinning of very or ultrahigh molecular weight polyethylene.

Isotropic polymers that cannot be processed in the melt may also be used as the at least one polymeric resin of the present inventions. In one embodiment, the isotropic polymer is rayon. In another embodiment, the isotropic polymer is cellulose acetate. In a further embodiment, the isotropic polymer is polybenzimidazole, poly[2,2′-(m-phenylene)-5,5′-bibenzimidazole]. In one embodiment, the isotropic polymers are dry spun using acetone as a solvent. In another embodiment, poly [2,2′-(m-phenylene)-5,5′-bibenzimidazole] is wet spun using N,N′-dimethylacetamide as a solvent. In yet another embodiment, the isotropic polymers are aromatic polyamides other than the polymer of terephthalic acid and p-phenylene diamine (e.g., polymers of terephthalic acid and one or more aromatic diamines) that are soluble in polar aprotic solvents, including but not limited to N-methylpyrrolidinone, that are wet spun with added particles to yield monofilament fibers. In a further embodiment, amorphous, non-crystalline, isotropic polymers, including but not limited to the copolymer of isophthalic acid, terephthalic acid and bisphenol A (polyarylate), may also be filled and utilized in the present inventions.

In another embodiment, the at least one polymeric resin is made from a liquid crystalline polymer (LCP). LCPs generally produce fibers with high tensile strength and/or modulus. In one embodiment, the liquid crystalline polymer is processable in the melt (i.e., thermotropic). In another embodiment, the liquid crystalline polymer cannot be processed in the melt. In a further embodiment, liquid crystalline polymers are used that exhibit liquid crystalline behavior in solution, are blended with a hard filler, and then wet or dry spun to yield monofilament fibers. In yet another embodiment, the aromatic polyamide made from p-phenylenediamine and terephthalic acid (including, but not limited to, polymers sold under the KEVLAR trademark) can be filled and wet spun (e.g., by dry-jet wet-spinning from a concentrated sulfuric acid solution) to yield monofilament fibers. In yet a further embodiment, the liquid crystalline polymer is any aromatic polyamide that is soluble in polar aprotic solvents, including but not limited to N-methylpyrrolidinone, and that can be spun into monofilament fibers. In still another embodiment, the liquid crystalline polymer is not liquid crystalline under some or all of a given condition or set of conditions, but still yields high modulus fibers. In still a further embodiment, the liquid crystalline polymer exhibits lyotropic liquid crystalline phases at some concentrations and in some solvents, but isotropic solutions at other concentrations and/or in other solvents.

In one embodiment, the liquid crystalline polymers (LCPs) for use in this invention are thermotropic LCPs. Exemplary thermotropic LCPs include, but are not limited to, aromatic polyesters, aliphatic-aromatic polyesters, aromatic poly(esteramides), aliphatic-aromatic poly(esteramides), aromatic poly(esterimides), aromatic poly(estercarbonates), aromatic polyamides, aliphatic-aromatic polyamides and poly(azomethines). In one embodiment, the thermotropic LCPs are aromatic polyesters and poly(esteramides) that form liquid crystalline melt phases at temperatures less than about 360° C. and include one or more monomer units derived from the group consisting of terephthalic acid, isophthalic acid, 1,4-hydroquinone, resorcinol, 4,4′-dihydroxybiphenyl, 4,4′-biphenyldicarboxylic acid, 4-hydroxybenzoic acid, 6-hydroxy-2-naphthoic acid, 2,6-naphthalenedicarboxylic acid, 2,6-dihydroxynaphthalene, 4-aminophenol, and 4-aminobenzoic acid. In one embodiment the aromatic groups include substituents which do not react under the conditions of the polymerization, such as lower alkyl groups having 1-4 carbons, aromatic groups, F, Cl, Br, and I. The synthesis and structure of some typical aromatic polyesters are taught in U.S. Pat. Nos. 4,473,682; 4,522,974; 4,375,530; 4,318,841; 4,256,624; 4,161,470; 4,219,461; 4,083,829; 4,184,996; 4,279,803; 4,337,190; 4,355,134; 4,429,105; 4,393,191; and 4,421,908. The synthesis and structures of some typical aromatic poly(esteramides) are taught in U.S. Pat. Nos. 4,339,375; 4,355,132; 4,351,917; 4,330,457; 4,351,918; and 5,204,443. Potentially useful aromatic liquid crystalline polyesters and poly(esteramides) may be those available from Hoechst Celanese Corporation under the VECTRA trademark, as well as from other manufacturers.

In yet another embodiment, the LCPs have monomer repeat units derived from 4-hydroxybenzoic acid and 6-hydroxy-2-naphthoic acid, as taught in U.S. Pat. No. 4,161,470. In one embodiment, the monomer units derived from 4-hydroxybenzoic acid comprise about 15% to about 85% of the polymer on a mole basis, and monomer units derived from 6-hydroxy-2-naphthoic acid comprise about 85% to about 15% of the polymer on a mole basis. In another embodiment, the polymer comprises about 73% monomer units derived from 4-hydroxybenzoic acid and about 27% monomer units derived from 6-hydroxy-2-naphthoic acid, on a mole basis. Such a polymer is available in fiber form under the VECTRAN trademark from Hoechst Celanese Corporation, Charlotte, N.C.

In still a further embodiment, the LCPs or poly(esteramides) comprise the above recited monomer units derived from 6-hydroxy-2-naphthoic acid and 4-hydroxybenzoic acid, as well as monomer units derived from one or more of the following monomers: 4,4′-dihydroxybiphenyl, terephthalic acid, and 4-aminophenol. In yet another embodiment, the polyester comprising these monomer units is derived from 4-hydroxybenzoic acid, 6-hydroxy-2-naphthoic acid, 4,4′-biphenol, and terephthalic acid, as taught in U.S. Pat. No. 4,473,682, with the polymer comprising these monomer units in a mole ratio of about 60:4:18:18. In another embodiment, the poly(esteramide) comprises monomer units derived from 4-hydroxybenzoic acid, 6-hydroxy-2-naphthoic acid, terephthalic acid, 4,4′-biphenol, and 4-aminophenol, as taught in U.S. Pat. No. 5,204,443. In yet another embodiment, the composition comprises these monomer units in a mole ratio of about 60:3.5:18.25:13.25:5.

In one embodiment, the at least one polymeric resin is a suitable commercial polymeric resin product. Exemplary commercial products suitable as the at least one polymeric resin include, but are not limited to: Basell Pro-fax 6323 polypropylene resin, a general purpose homopolymer with a density of about 0.9 g/cm³ and a melt flow index of about 12.0 g/10 min, available from LyondellBasell Industries; Exxon 3155, a polypropylene homopolymer having a melt flow rate of about 30 g/10 min, available from Exxon Mobil Corporation; PF 305, a polypropylene homopolymer having a melt flow rate of about 38 g/10 min, available from Montell USA; ESD47, a polypropylene homopolymer having a melt flow rate of about 38 g/10 min, available from Union Carbide; and 6D43, a polypropylene-polyethylene copolymer having a melt flow rate of about 35 g/10 min, available from Union Carbide.

The at least one polymeric resin may be present in the monofilament fibers of the present disclosure in an amount of greater than or equal to about 50 wt %, relative to the total weight of the fibers. In one embodiment, the at least one polymeric resin is present in the fibers in an amount ranging from about 50 to about 90 wt %. In another embodiment, the at least one polymeric resin is present in the fibers in an amount ranging from about 75 to about 90 wt %.

Filler

The monofilament fibers comprise at least one filler. The skilled artisan will readily understand appropriate fillers for use in the inventions described herein. In one embodiment, the at least one filler is any mineral-based substrate capable of being coated, mixed with at least one polymeric resin, and extruded. In another embodiment, the at least one filler is coated ground calcium carbonate. Coated ground calcium carbonate is a filler commonly used in the formation of various polymeric products. In a further embodiment, the at least one filler is chosen from the group consisting of coated ground calcium carbonate, limestone, talc, and clay products. In yet another embodiment, the at least one filler is a clay product chosen from the group consisting of kaolins and calcined clays.

Exemplary coated ground calcium carbonate products suitable for use as an at least one filler include, but are not limited to, those commercially available. In one embodiment, the coated ground calcium carbonate is chosen from those products sold under the name FiberLink™ by Imerys, Inc. In another embodiment, the coated ground calcium carbonate is the product sold under the name MAGNUM GLOSS® by the Mississippi Lime Company. In a further embodiment, the coated ground calcium carbonate is the product sold under the name ALBAGLOS® by Specialty Minerals, Inc. In yet another embodiment, the coated ground calcium carbonate is the product sold under the name OMYACARB® by OMYA, Inc. In yet a further embodiment, the coated ground calcium carbonate is the product sold under the name HUBERCARB® by Huber, Inc. In still another embodiment, the coated ground calcium carbonate is the product sold under the name FiberLink™ 101S by Imerys, Inc. Exemplary commercially available coated ground calcium carbonate products may be available in the form of dry powders having defined particle size ranges; however, not all commercial coated ground calcium carbonate products will exhibit a particle size and distribution appropriate for use in accordance with the present disclosure.

The particle size of the at least one filler may affect, among other things, the maximum amount of filler effectively incorporated into the monofilament fibers disclosed herein, as well as the aesthetic properties and strength of the resulting products. In one embodiment, the at least one filler has an average particle size less than or equal to about 10 microns. In another embodiment, the at least one filler has an average particle size ranging from about 1 micron to about 10 microns. In a further embodiment, the at least one filler has an average particle size of about 1 micron. In yet another embodiment, the at least one filler has an average particle size less than or equal to about 4 microns. In yet a further embodiment, the at least one filler has an average particle size less than or equal to about 3 microns. In still another embodiment, the at least one filler has an average particle size less than or equal to about 2 microns. In still a further embodiment, the at least one filler has an average particle size less than or equal to about 1.5 microns. In another embodiment, the at least one filler has an average particle size less than or equal to about 1 micron. In a further embodiment, the at least one filler has an average particle size ranging from about 1 micron to about 4 microns. In yet another embodiment, the at least one filler has an average particle size ranging from about 1 micron to about 3 microns. In yet a further embodiment, the at least one filler has an average particle size ranging from about 1 micron to about 2 microns. In still another embodiment, the at least one filler has an average particle size ranging from about 0.5 microns to about 1.5 microns. Average particle size is defined herein as the d₅₀ as measured on a Microtrac® 100 particle size analyzer.

The at least one filler may be characterized by a “top cut” value. As used herein, “top cut” refers to the largest particle size that can be identified in a sample of filler by a Microtrac® 100 particle size analyzer. In one embodiment, the top cut is less than about 10 microns. In a further embodiment, the top cut is less than about 8 microns. In yet another embodiment, the top cut is less than about 6 microns. In yet a further embodiment, the top cut is less than about 4 microns. In still another embodiment, the top cut ranges from about 4 microns to about 10 microns. In a further embodiment, the top cut ranges from about 4 microns to about 8 microns. In yet another embodiment, the top cut ranges from about 4 microns to about 6 microns. In still another embodiment, the top cut is less than the diameter of the monofilament fibers.

The particle size distribution of the at least one filler according to the present disclosure may be small enough so as to not significantly weaken the individual fibers and/or make the surface of the fibers abrasive, but large enough so as to create an aesthetically pleasing surface texture. In one embodiment, the particle size distribution of the at least one filler has less than about 5% of the total particles greater than about 10 microns, and less than about 5% of the total particles less than about 0.5 microns. Particles above about 10 microns may tend to weaken the structure, and particles less than about 0.5 microns may tend to form agglomerates, leading to formation of structures greater than about 10 microns.

The at least one filler may be coated with at least one organic material. In one embodiment, the at least one organic material is chosen from fatty acids, including but not limited to stearic acid, and salts and esters thereof, such as stearate. In another embodiment, the at least one organic material is ammonium stearate. In a further embodiment, the at least one organic material is calcium stearate. The products sold under the tradename FiberLink™ by Imerys, Inc., are non-limiting examples of ground calcium carbonate products coated with stearic acid.

Surface coating the at least one filler with at least one organic material may, in some embodiments, serve to improve dispersion of the at least one filler particles throughout the fiber and/or facilitate the overall production of the fibers. For example, the addition of uncoated ground calcium carbonate to at least one polymeric resin, as opposed to coated ground calcium carbonate, results in fibers having uncoated ground calcium carbonate particles located on the outside of the fibers, which may be problematic because uncoated particles located on the outside of the fibers may cause inorganic deposits to attach to metal components of the spinneret die holes and clog the exit holes, thus preventing the fibers from extruding properly.

The amount of the at least one filler may negatively impact the strength and/or surface texture of the monofilaments fibers if it exceeds a certain value. In one embodiment, the at least one filler is present in an amount less than about 50 wt %, relative to the total weight of the fibers. In another embodiment, the at least one filler is present in an amount less than about 25 wt %. In a further embodiment, the at least one filler is present in an amount less than about 20 wt %. In yet another embodiment, the at least one filler is present in an amount less than about 15 wt %. In yet a further embodiment, the at least one filler is present in an amount less than about 10 wt %. In yet still another embodiment, the at least one filler is present in an amount ranging from about 5 wt % to about 40 wt %. In still another embodiment, the at least one filler is present in an amount ranging from about 10 wt % to about 20 wt %. In still another embodiment, the at least one filler is present in an amount ranging from about 10 wt % to about 15 wt %. In yet another embodiment, the at least one filler is present in an amount from about 10 wt % to about 25 wt % when the at least one filler has an average particle size of less than about 3 microns and/or a top cut of less than about 10 microns.

Optional Additives

In addition to the at least one polymeric resin and the at least one filler, the monofilament fibers may further comprise at least one additive. The at least one additive may be chosen from those now known in the art or those hereafter discovered. In one embodiment, the at least one additive is chosen from additional mineral fillers, including but not limited to, talc, gypsum, diatomaceous earth, kaolin, attapulgite, bentonite, montmorillonite, and other natural or synthetic clays. In another embodiment, the at least one additive is chosen from inorganic compounds, including but not limited to silica, alumina, magnesium oxide, zinc oxide, calcium oxide, and barium sulfate. In a further embodiment, the at least one additive is chosen from one of the group consisting of: optical brighteners; heat stabilizers; antioxidants; antistatic agents; anti-blocking agents; dyestuffs; pigments, including but not limited to titanium dioxide; luster improving agents; surfactants; natural oils; and synthetic oils.

### Processes for Producing Monofilament Fibers

Monofilament fibers, as discussed herein, may be produced according to any appropriate process or processes now known to the skilled artisan or hereafter discovered, that result in the production of a continuous monofilament fiber comprising at least one polymeric resin and at least one filler. Exemplary techniques include, but are not limited to, dry spinning, wet spinning, spun-bonding, flash-spinning, needle-punching, meltblowing, and water-punching processes. One particular exemplary process for producing monofilament fibers is melt spinning, which may employ an extrusion process to provide molten polymer mixtures to spinneret dies. In one embodiment, melt spinning may be accomplished using DuPont fiber spinning equipment, such as that available at the time this application was filed at Clemson University in Clemson, S.C., USA.

In one embodiment, the process for producing monofilament fibers according to the present invention comprises heating the at least one polymeric resin to at least about its softening point. In another embodiment, the process comprises heating the at least one polymeric resin to any temperature suitable for the extrusion of the at least one polymeric resin. In a further embodiment, the at least one polymeric resin is heated to a temperature ranging from about 225° C. to about 260° C.

The at least one filler may be incorporated into the at least one polymeric resin using any method conventionally known in the art or hereafter discovered. For example, the at least one filler may be added to the at least one polymeric resin during any step prior to extrusion, for example, during or prior to the heating step. In another embodiment, a “masterbatch” of at least one polymeric resin and the at least one filler may be premixed, optionally formed into granulates or pellets, and mixed with at least one additional virgin polymeric resin before extrusion of the fibers. The at least one additional virgin polymeric resin may be the same or different from the at least one polymeric resin used to make the masterbatch. In certain embodiments, the masterbatch comprises a higher concentration of the at least one filler, for instance, a concentration ranging from about 20 wt % to about 75 wt %, than is desired in the final product, and may be mixed with the at least one additional polymeric resin in an amount suitable to obtain the desired concentration of at least one filler in the final monofilament fiber product. In one embodiment, the concentration of the at least one filler in the masterbatch is about 20 wt % to about 75 wt %. In another embodiment, the concentration is about 20 wt % to about 50 wt %. For example, a masterbatch comprising 50 wt % coated ground calcium carbonate may be mixed with an equal amount of at least one virgin polymeric resin to produce a final product comprising 25 wt % coated ground calcium carbonate. The masterbatch may be mixed and pelletized using any apparatus known in the art or hereafter discovered, for example, a ZSK 30 Twin Extruder may be used to mix and extrude the coated ground calcium carbonate and at least one polymer resin masterbatch, and a Cumberland pelletizer may be used to optionally form the masterbatch into pellets.

Once the at least one filler or masterbatch is mixed with the at least one polymeric resin, the mixture may be extruded continuously through at least one spinneret to produce long filaments. The extrusion rate may vary according to the desired application, and appropriate extrusion rates will be known to the skilled artisan.

The extrusion temperature may also vary depending on the desired application and process. In one embodiment, the extrusion temperature ranges from about 225° C. to about 260° C. In another embodiment, the extrusion temperature ranges from about 235° C. to about 245° C. The extrusion apparatus may be chosen from those conventionally used now or hereafter discovered in the art. In one embodiment, the extrusion apparatus is an Alex James 0.75 inch single screw extruder with a 0.297 cc/rev metering pump. The at least one spinneret may be chosen from those conventionally used now or hereafter discovered in the art. In one embodiment, the at least one spinneret contains 10 holes, each about 0.022 inches in diameter.

After extrusion, the monofilament fibers may be attenuated. In one embodiment, the fibers are attenuated by high-speed drawing, in which the multi-strand filament is drawn out on rollers such that the wind speed is about 1000 meters per minute.

The monofilament fibers may be produced to have a desired size. Those of ordinary skill in the art will know appropriate sizes of the monofilament fibers for the desired or intended application, and processes for measuring them. In one embodiment, the monofilament fibers range in size from about 0.1 denier to about 120 denier. In another embodiment, the monofilament fibers range in size from about 1 denier to about 100 denier. In a further embodiment, the monofilament fibers range in size from about 0.5 to about 5 denier. In yet another embodiment, the monofilament fibers are about 100 denier in size.

### Testing

The fibers disclosed herein may be tested by any number of various methods and for any number of various properties, including for their individual fiber strength, elongation at break, and tenacity. Those three tests may be conducted using, for example, ASTM D3822.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, unless otherwise indicated the numerical values set forth in the specific examples are reported as precisely as possible. Any numerical value, however, inherently contains certain errors resulting from the standard deviation found in the respective testing measurements.

The headers used in this specification are presented for the convenience of the reader and not intended limit the inventions described herein. By way of non-limiting illustration, examples of certain embodiments of the present disclosure are given below.

### EXAMPLES

### Example 1

The at least one filler in this Example was a low solids processed, uncoated ground calcium carbonate (Supermite®, Imerys, Inc.) with an average particle size of about 1.5 microns and a top cut of about 10 microns. The filler was compounded at various weight percentages with Basell Profax 6323 polypropylene resin, a general purpose homopolymer with a density of 0.9 g/cm³ and a melt flow index of 12.0 g/10 min. Monofilament fibers were produced, when possible, using a standard melt fiber spinning process.

At 5% loadings, the uncoated product experienced immediate processing problems where even 4 denier fibers could not be produced, even at low line speeds, without fiber breaks. This trial was not conducted long enough for the powder to plate out and clog the spinneret holes, but previous evaluations indicate it would have happened.

### Example 2

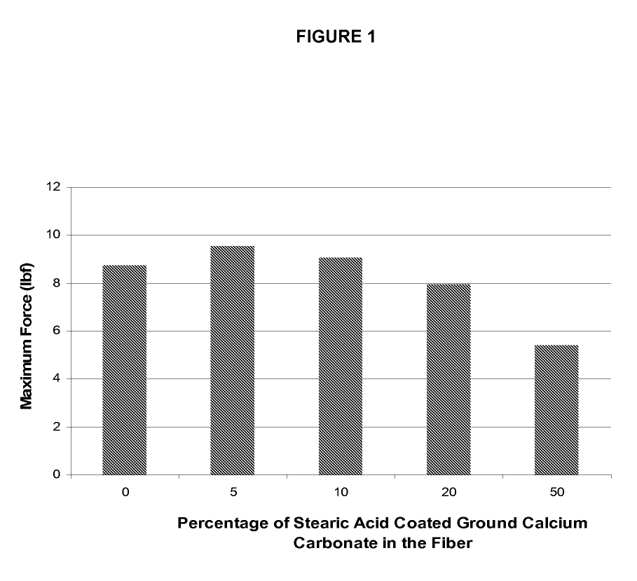

This example used as the at least one filler a low solids processed, stearic acid coated calcium carbonate with an average particle size of 1.5 micron and a top cut of 8 microns, sold by Imerys, Inc. under the trade name FiberLink™ 101S. The stearic acid target was about 1% by weight. The virgin resin was a 12 MFI homopolymer polypropylene supplied by Atofina. Tests of the resulting fibers were conducted using ASTM D3822y conditions at additive loadings of about 0%, about 5%, about 10%, about 20%, and about 50%. Continuous fibers were produced at target sizes of 4, 3, and 2 denier, using the same standard melt fiber spinning process as in Example 1. Prototypes containing about 50% additive loadings could not be produced at 2 denier. The strength properties of 3 denier monofilament fibers are shown in FIGS. 1, 2, and 3 and summarized below in Table 1.

TABLE 1

| Coated Ground | | | |
|---|---|---|---|
| Calcium Carbonate | Maximum Load | Elongation at Break | Tenacity |
| in the Fiber (%) | (lb_{f}) | (%) | (g/den) |
| 0% | 8.74 | 370 | 2.91 |
| 5% | 9.55 | 352 | 3.18 |
| 10% | 9.04 | 308 | 3.01 |
| 20% | 7.96 | 188 | 2.65 |
| 50% | 5.40 | 127 | 1.80 |

The individual fiber strength (maximum load) shown in Table 1 and FIG. 1 was reasonably level for percentages of stearic acid coated ground calcium carbonate in the fiber up to about 20%. The results at 50% were lower, but the 3 denier fibers could still be produced at over 1000 meters per minute.

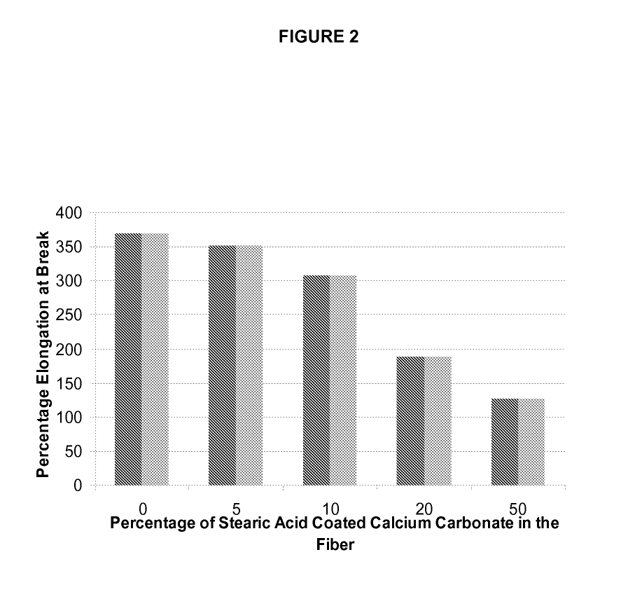

When measuring the elongation at the break for the individual fibers, the cold fibers were stretched and the results are shown in Table 1 and FIG. 2. For 3 denier fibers, a sharp decrease elongation at break occurred between about 10% and about 20% of stearic acid coated ground calcium carbonate in the fibers.

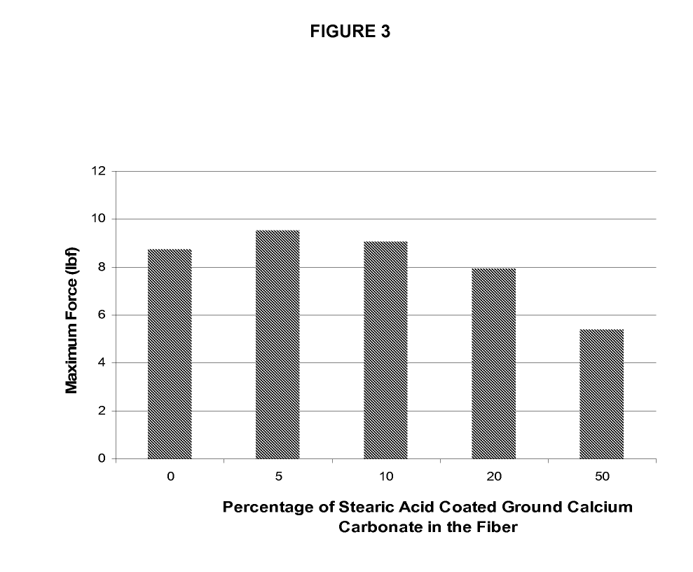

The individual fiber tenacity shown in Table 1 and FIG. 3 was reasonably consistent over the range of about 0% to about 20% of stearic acid coated ground calcium carbonate in the fiber.

Results with 2 and 4 denier fibers illustrated similar trends that were overall not inconsistent with those of Table 1 and FIG. 1-3.

1-92. (canceled)

93. A monofilament fiber comprising at least one polymeric resin and at least one coated filler having a top cut of less than about 10 microns, wherein the at least one coated filler comprises at least one ground calcium carbonate and at least one coating, and wherein the at least one coated filler is present in the fiber in an amount less than about 50 wt %, relative to the total weight of the monofilament fiber.

94. The monofilament fiber of claim 93, wherein the at least one ground calcium carbonate is present in an amount less than about 25 wt %, relative to the total weight of the monofilament fiber.

95. The monofilament fiber of claim 93, wherein the at least one ground calcium carbonate is present in an amount less than about 15 wt %, relative to the total weight of the monofilament fiber.

96. The monofilament fiber of claim 93, wherein the at least one coating comprises at least one organic material chosen from fatty acids and salts and esters thereof.

97. The monofilament fiber of claim 96, wherein the at least one organic material is chosen from stearic acid, stearate, ammonium stearate, and calcium stearate.

98. The monofilament fiber of claim 93, wherein the at least one polymeric resin comprises at least one thermoplastic polymer.

99. The monofilament fiber of claim 98, wherein the at least one thermoplastic polymer is chosen from the group consisting of polyolefins, polyamides, polyesters, copolymers thereof, and blends thereof.

100. The monofilament fiber of claim 99, wherein the polyolefins are chosen from polypropylene and polyethylene homopolymers and copolymers.

101. The monofilament fiber of claim 93, wherein the at least one polymeric resin has a melt flow rate of about 12 g/10 min.

102. The monofilament fiber of claim 93, further comprising at least one additive chosen from additional mineral fillers, inorganic compounds, waxes, optical brighteners, heat stabilizers, antioxidants, anti-static agents, anti-blocking agents, dyestuffs, pigments, luster improving agents, surfactants, natural oils, and synthetic oils.

103. The monofilament fiber of claim 93, wherein the at least one ground calcium carbonate has a top cut of less than about 10 microns.

104. The monofilament fiber of claim 93, wherein the at least one ground calcium carbonate has a top cut of less than about 6 microns.

105. The monofilament fiber of claim 93, wherein the at least one ground calcium carbonate has a top cut ranging from about 4 microns to about 10 microns.

106. The monofilament fiber of claim 93, wherein the at least one ground calcium carbonate has a top cut ranging from about 4 microns to about 8 microns.

107. The monofilament fiber of claim 93, wherein the at least one ground calcium carbonate has an average particle size of less than or equal to about 3 microns.

108. The monofilament fiber of claim 93, wherein the at least one ground calcium carbonate has an average particle size ranging from about 1 micron to about 3 microns.

109. The monofilament fiber of claim 93, wherein the at least one ground calcium carbonate has an average particle size ranging from about 0.5 micron to about 2 microns.

110. The monofilament fiber of claim 93, wherein the monofilament fiber has a size ranging from about 0.5 to about 5 denier.

111. A process for producing monofilament fibers comprising:
mixing at least one polymeric resin with at least one coated ground calcium carbonate having an average particle size of less than or equal to about 3 microns;
heating the mixture at least to the softening point of the at least one polymeric resin; and
extruding the mixture to form monofilament fibers,
wherein the at least one coated ground calcium carbonate is present in the monofilament fibers in an amount less than about 50 wt %, relative to the total weight of the monofilament fibers.

112. A monofilament fiber comprising at least one polymeric resin and at least one coated filler having an average particle size of less than or equal to about 3 microns and having a top cut of less than about 10 microns, wherein the at least one coated filler is present in the fiber in an amount less than about 50 wt %, relative to the total weight of the monofilament fiber, and wherein the at least one coated filler is ground calcium carbonate coated with stearic acid.
